(19) United States
(12) Patent Application Publication
(10) Pub. No.: US 2014/0201103 A1
(43) Pub. Date: Jul. 17, 2014

(54) SYSTEM FOR RESEARCH AND DEVELOPMENT INFORMATION ASSISTING IN INVESTMENT, AND A METHOD, A COMPUTER PROGRAM, AND A READABLE AND RECORDABLE MEDIA FOR COMPUTER THEREOF

(71) Applicant: NATIONAL CHENG KUNG UNIVERSITY, Tainan City (TW)

(72) Inventors: Yi-Ching LIN, Kaohsiung City (TW); Gen-Ming GUO, Kaohsiung City (TW); Zhong-Xiang XIAO, Keelung City (TW)

(73) Assignee: NATIONAL CHENG KUNG UNIVERSITY, Tainan City (TW)

(21) Appl. No.: 13/740,924

(22) Filed: Jan. 14, 2013

(51) Int. Cl. G06Q 40/06

(52) U.S. Cl. CPC G06Q 40/06
USPC 705/36 R

(57) ABSTRACT

A system for research and development information assisting in investment, and a method, a computer program, and a readable and recordable media for computer thereof are disclosed. The system comprises a processing unit, a database module, an investment analysis subsystem, and an output unit, and provides a method, a computer program or a readable and recordable media for computer. The investment analysis subsystem compares an academic document with a patent document to generate a technical relevancy, providing the user to determine whether a patent document of the target enterprise is forward-looking or whether too many popular patents are owned. Therefore, users can choose to enter the market earlier when the stock price of the enterprise is underestimated or exit earlier before the invested enterprise reduces the turnover and the enterprise value due to a vicious competition and a price reduction strategy of competitors, thereby ensuring investors' profits.

### FIELD OF THE INVENTION

The present invention relates to a system for research and development information assisting in investment, an a method, a computer program, and a readable and recordable media for computer thereof, in particular to compare the patent documents owned by the enterprise with the academic documents of different years so as to know whether an enterprises owns the forward-looking of research and development technique or has too many popular patents for a determination of investment policy.

### BACKGROUND OF THE INVENTION

The conventional stock picking system mostly analyzes in relation to the financial statement and the financial ratio data of the enterprise for the basis of stock picking, but rarely analyzes in relation to the research and development and the innovated ability of the enterprise. The research and development and the innovated ability of the enterprise are concerned that if the enterprise is able to build a higher technical threshold, enhance the sales value, develop a new market, and maintain the market share. Therefore, if the analysis related to the research and development and the innovated ability of the enterprise are not incorporated into the stock picking system as a picking basic, the future turnover and the enterprise value of the enterprise are easily underestimated. The judgments regarding to the research and development and the innovated ability of the enterprise usually depend on patents owned by the enterprise as a reference index.

To compare with the research fund, the patent itself implies more abundant information for the investor to estimate the market value of the research and development activities. For instance, the number of the patents is regarded as the accumulated research and development achievements of the company in the past, the quoted record of the patent reflects the connection between each of the patents, the influences for the following innovation, and the value of the patent itself (which is quoted from the master dissertation, “Patent, R&D Activities, and Stock Market Reactions—The Case, of R&D Spending”, written by Yu-hui YEH from the department of Institute of International Business of National Cheng Kung University, in June, 2003.)

Referring to the American patent number US20090012827, by “Methods and Systems for Analyzing Patent Application to Identify Undervalued Stocks” is disclosed. The prior art mainly uses the rate of patent quotation to evaluate whether the patent is forward-looking in the future and estimate if the stock price of the company owning the patent is underestimated as the investing reference. In this prior art, only the rate of the patent quotation is used, the analysis resources are few, which can only know the quality of the research and development technique and not easy to know the company value directly.

Referring to the Taiwan patent number I249692, by “innovation-oriented investment portfolio decision system”, is disclosed. This prior patent comprises a search module, a patent indicator index module, and an investment portfolio module; wherein, the patent indicator index module includes at least one patent indicator group composed of a number of patent, a growth rate of patents, a patent efficiency, a quoted number of patent, a life circle of the technique, and a science relevancy. The patent indicator also includes the conventional current impact index, technology strength, or science strength, thereby achieving the purpose of the stock picking evaluation point of view by patent indicator index.

However, this prior art provides many patents as an index of investing reference, such as number of patent, growth rate of patents, patent efficiency, science relevancy, and science strength though, these indexes are not easy to determine whether the research and development of the enterprise is on the peak of industries and sets a technical threshold as soon as possible, or sticks in the mud and faces the vicious competition and the price reduction strategy.

For further detailed description, the forward-looking of the patent is determined according to the number of the foregoing patent quotation though, however, the number of quotations for providing determinable data still stands on the quotations cited in the patents which are put into allowance in the future.

The mentioned science relevancy is calculated by the quantity and the frequency of science documents as cited in the specification when a patent is published. A patent has to disclose the background of related references that are mainly derived from the scientific documentations and other related patents. However, readers cannot exactly catch the references since these reference cited or quoted in the specification of the patent depends on the submission of the inventor. It is also hard to know if the quoted references in the specification are prospective or forward-looking. Therefore, the practicability is still insufficient.

For the investor who wants to take the patent documents as the invest reference, the prospect of the patent is still hard to be known presently. Even the investor knows the prospect, the patent technique has usually been a popular technique, which renders the investor unable to enter the market earlier when the enterprise stock price is underestimated. Therefore, the profit of the investor is hardly expanded and the system still has the defect of practicability.

### SUMMARY OF THE INVENTION

It is therefore the patent documents being able to be determined if the research and development of the enterprise is forward-looking. The inventor is devoted to the research and brings up a system for research and development information assisting in investment comprising:

A processing unit;

A database module connected to the processing unit. The database module includes a research and development information database and an analysis report database. The research and development information is applied to import an external data. The external data has at least one academic document and at least one patent document;

An investment analysis subsystem built in the processing unit. The investment analysis subsystem is connected to the research and development information database and the analysis report database. The investment analysis subsystem compares the academic document with patent document to obtain a technical relevancy and saves the technical relevancy in the analysis report database; and

An output unit connected with the processing unit for outputting the technical relevancy of the analysis report database by the processing unit.

Preferably, the investment analysis subsystem includes a word segmentation module, a statistic term frequency probability module, and an estimation module. The word segmentation module is applied to segment the academic document and the patent document to generate a plurality of linguistic units. The statistic term frequency probability module is applied to add up an appeared frequency of the linguistic units for sifting out a plurality of technical key words. The estimation module determines a repeatability by comparing the technical key words of the patent document with the key words of the academic document to generate the technical relevancy.

Preferably, the analysis report database is a buying analysis report database, and the investment analysis subsystem is a buying analysis subsystem. A time period of the academic document of the external data adopted by the buying analysis subsystem is set within n year(s) satisfying a condition of n≦2. The estimation module compares the technical relevancy of the academic document and the patent document to determine whether the patent document is a forward-looking patent for a buying reference.

Preferably, the technical relevancy of the academic document and the patent document is applied to compute a buying reference index of a company. A calculation formula of the buying reference index includes:

Wi (quantity of the forward-looking patent): A number of the forward-looking patent owned by the company;

Wj (quality of the forward-looking patent): A number of times that the forward-looking patent owned by the company is quoted.

Preferably, a calculation formula of the company's enter reference index further includes:

Wy (growth rate of patents): A sum of granted patents within a time period of n year(s) satisfying a condition of n≦1/a sum of granted patents for a time period of n year(s) satisfying a condition of n≦2;

Wz (growth rate of research and development awards): A sum of awards in research and development within a time period of n year(s) satisfying a condition of n≦1/a sum of awards in research and development for a time period of n year(s) satisfying a condition of n≦2;

Wk (patent gap rate of main competitors): A gap between patent quantity and quality of the company and competitors within n year(s) satisfying a condition of n≦1;

Wg (growth rate of foreign patents): A sum of granted foreign patents within a time period of n year(s) satisfying a condition of n≦1/a sum of granted foreign patents for a time period of n year(s) satisfying a condition of n≦2.

Preferably, the analysis report database is a selling analysis report database, and the investment analysis subsystem is a selling analysis subsystem. A time period of the academic document of the external data adopted by the selling analysis subsystem is set for n year(s) satisfying a condition of 5≦n≦10. The estimation module compares the technical relevancy of the academic document and the patent document to determine whether the patent document is a popular patent for a selling reference.

Preferably, the technical relevancy of the academic document and the patent document is applied to compute a selling reference index of a company. A calculation formula of the selling reference index includes:

Wm (quantity of popular patent): A number of the popular patent owned by the company;

Wn (quality of popular patent): A number of times that the popular patent owned by the company is quoted.

Preferably, the calculation formula of the company's exit reference index includes:

Wy (growth rate of patents): A sum of granted patents within a time period of n year(s) satisfying a condition of n≦1/a sum of granted patents for a time period of n year(s) satisfying a condition of n≦2;

Wz (growth rate of research and development awards): A sum of awards in research and development within a time period of n year(s) satisfying a condition of n≦1/a sum of awards in research and development for a time period of n year(s) satisfying a condition of n≦2;

Wk (patent gap rate of main competitors): A gap between patent quantity and quality of the company and competitors within n year(s) satisfying a condition of n≦1;

Wg (growth rate of foreign patents): A sum of granted foreign patents within a time period of n year(s) satisfying a condition of n≦1/a sum of granted foreign patents for a time period of n year(s) satisfying a condition of n≦2.

Preferably, a forward-looking patent verification subsystem is further included. The forward-looking patent verification subsystem is built in the processing unit. The forward-looking patent verification subsystem is connected to the buying analysis report database. The forward-looking patent verification subsystem includes a first management module, a first usefulness survey module, and a first easy-to-use survey module. The first management module is applied to verify years of the buying reference index in the buying analysis report database. The first usefulness survey module provides a usefulness-estimated questionnaire for estimating a usefulness of the buying reference index. The first easy-to-use survey module provides a easy-to-use-estimated questionnaire for estimating an acceptance of a user interface of the buying analysis module.

Preferably, a popular patent verification subsystem is further included. The popular patent verification subsystem is built in the processing unit. The popular patent verification subsystem is connected to the selling analysis report database. The popular patent verification subsystem includes a second management module, a second usefulness survey module, and a second easy-to-use survey module. The second management module is applied to verify years of the selling reference index in the selling analysis report database. The second usefulness survey module provides a usefulness-estimated questionnaire for estimating a usefulness of the selling reference index. The second easy-to-use survey module provides a easy-to-use-estimated questionnaire for estimating an acceptance of a user interface of the selling analysis module.

Preferably, a searching and browsing subsystem and an operation unit are further included. The searching and browsing subsystem is built in the processing unit and connected to the analysis report database. The operation unit is electrically connected to the processing unit for inputting an operation signal. The output unit is defined as a screen for the processing unit to output a searching page and/or a browsing page in accordance with the operation signal.

Preferably, a factor estimation subsystem is further included. The factor estimation subsystem is built in the processing unit and connected to the investment analysis subsystem. The factor estimation subsystem includes a reviewal module, a ranking module, a term frequency calculating module, a binary questionnaire survey module or a combination thereof. The reviewal module is applied to control the investment analysis subsystem to repeatedly confirm the technical relevancy. The rank module arranges the technical relevancy in order of integrations when the technical relevancy is plural. The binary questionnaire survey module is applied to provide at least one binary questionnaire and render the investment analysis subsystem able to adjust an analysis weight factor in accordance with a result of the binary questionnaire.

A system for research and development information assisting in investment is also provided and comprises:

A processing unit;

A database module connected with the processing unit. The database module includes a research and development information database, a buying analysis report database, and a selling analysis report database. The research and development information database is applied to import an external data. The external data includes at least one academic document and at least one patent document;

A buying analysis subsystem built in the processing unit. The investment analysis subsystem is connected to the research and development information database and the buying analysis report database. A time period of the academic document of the external data adopted by the buying analysis subsystem is set within n year(s) satisfying a condition of n 2. The estimation module compares the technical relevancy of the academic document and the patent document to determine whether the patent document is a forward-looking patent for a buying reference;

The buying analysis subsystem applies the technical relevancy of the academic document and the patent document for computing a buying reference index of a company. A calculation formula of the buying reference index includes:

Wi (quantity of the forward-looking patent): A number of the forward-looking patent owned by the company;

Wj (quality of the forward-looking patent): A number of times that the forward-looking patent owned by the company is quoted;

A selling analysis subsystem built in the processing unit. The investment analysis subsystem is connected to the research and development information and the selling analysis report database. A time period of the academic document of the external data adopted by the selling analysis subsystem is set for n year(s) satisfying a condition of 5≦n≦10. The estimation module compares the technical relevancy of the academic document and the patent document to determine whether the patent document is a popular patent for a selling reference;

The selling analysis subsystem applies technical relevancy of the academic document and the patent document for computing a selling reference index of the company. A calculation formula of the selling reference index includes:

Wm (quantity of popular patent): A number of the popular patent owned by the company;

Wn (quality of popular patent): A number of times that the popular patent owned by the company is quoted;

A factor estimation subsystem built in the processing unit. The factor estimation subsystem is connected to the investment analysis subsystem. The factor estimation subsystem includes a reviewal module, a ranking module, a term frequency calculating module, a binary questionnaire survey module or a combination thereof. The reviewal module is applied to repeatedly confirm the technical relevancy, the buying reference index, and the selling reference index. The ranking module arranges the technical relevancy, the buying reference index, and the selling reference index in order of integrations when the technical relevancy, the buying reference index, and the selling reference index are plural. The binary questionnaire survey module is applied to provide at least one binary questionnaire and render the investment analysis subsystem able to adjust an analysis weight factor in accordance with a result of binary questionnaire; and

An output unit connected with the processing unit for outputting the technical relevancy, the buying reference index, and the selling reference index of the analysis report database by the processing unit.

A method for research and development information assisting in investment is applied to a computer system. The method includes steps of:

Import an external data. The external data includes at least one academic document and at least one patent document; and

Compare the academic document with the patent document technically to result a technical relevancy.

Preferably, the steps comprise verifying the technical relevancy and making a feedback of verified result for updating the data anytime.

Preferably, the steps comprise segmenting the academic document and the patent document to generate a plurality of linguistic units, adding up an appeared frequency of the linguistic unit for sifting out a plurality of technical key words, and comparing a repeatability of the technical key words of the patent document with the technical key words of the academic document to generate the technical relevancy.

Preferably, a time period of the adopted academic document of the external data is set within n year(s) satisfying a condition of n≦2. The patent document is determined whether the patent document is a forward-looking patent for a buying reference by comparing the technical relevancy of the academic document and the patent document.

Preferably, a technical relevancy of the academic document and the patent document is applied to compute a buying reference index of a company. A calculation formula of the buying reference index includes:

Wi (quantity of the forward-looking patent): A number of the forward-looking patent owned by the company;

Wj (quality of the forward-looking patent): A number of times that the forward-looking patent owned by the company is quoted.

Preferably, a timer period of the adopted academic document of the external data is set for n year(s) satisfying a condition of 5≦n≦10. The patent document is determined whether the patent document is a popular patent for a selling reference by comparing the technical relevancy of the academic document and the patent document.

Preferably, the technical relevancy of the academic document and the patent document is applied to compute a selling reference index of a company. A calculation formula of the selling reference index includes:

Wm (quantity of popular patent): A number of the popular patent owned by the company;

Wn (quality of popular patent): A number of times that the popular patent owned by the company is quoted.

A computer program is further provided. Either of the methods for research and development information assisting in investment mentioned above is carried out when a computer loads the computer program.

A readable and recordable media for computer is further provided. Either of the methods for research and development information assisting in investment mentioned above is carried out after a computer loads the readable and recordable media.

In one aspect of the present invention, the present invention compares the patent documents of the enterprise with the textbooks, journal papers, theses or dissertations, and seminar/conference papers in recent years for knowing the prospect of the enterprise research and development technique as earlier as possible, so the investor can enter the market earlier when the future turnover and the enterprise value of the enterprise are underestimated to increase the investment profit, which is beneficial to the investor's profit.

In another aspect of the present invention, the present invention compares the patent documents of the enterprise with the popular textbooks, journal papers, theses or dissertations, and seminar/conference papers for knowing if the enterprise has too many popular patents, so the investor can exit earlier before the future turnover and the enterprise value of the invested enterprise are reduced due to the vicious competition and price reduction strategy from other competitors, which ensures the investment profit of the investor.

In further another aspect of the present invention, the present invention combines the methods of information classification analysis, conformity calculation, cross-reference verification, and estimation sifting so as to enhance the accuracy and easy-to-use of the analysis data of the system.

### BRIEF DESCRIPTION OF THE DRAWINGS

FIG. 1 is a schematic view showing a system frame of a first preferred embodiment of the present invention;

FIG. 2 is a flow diagram showing an analyzing method of the first preferred embodiment of the present invention;

FIG. 3 is a schematic view showing the first preferred embodiment of the present invention in operating;

FIG. 4 is a schematic view showing an interface of a buying analysis subsystem of the first preferred embodiment of the present invention;

FIG. 5 is a schematic view showing an interface of a selling analysis subsystem of the first preferred embodiment of the present invention; and

FIG. 6 is a schematic view showing an image of a binary questionnaire survey of a factor estimation subsystem.

### DETAILED DESCRIPTION OF THE PREFERRED EMBODIMENT

Combining the mentioned techniques, a system for research and development information assisting in investment 100 of the present invention is described as follows.

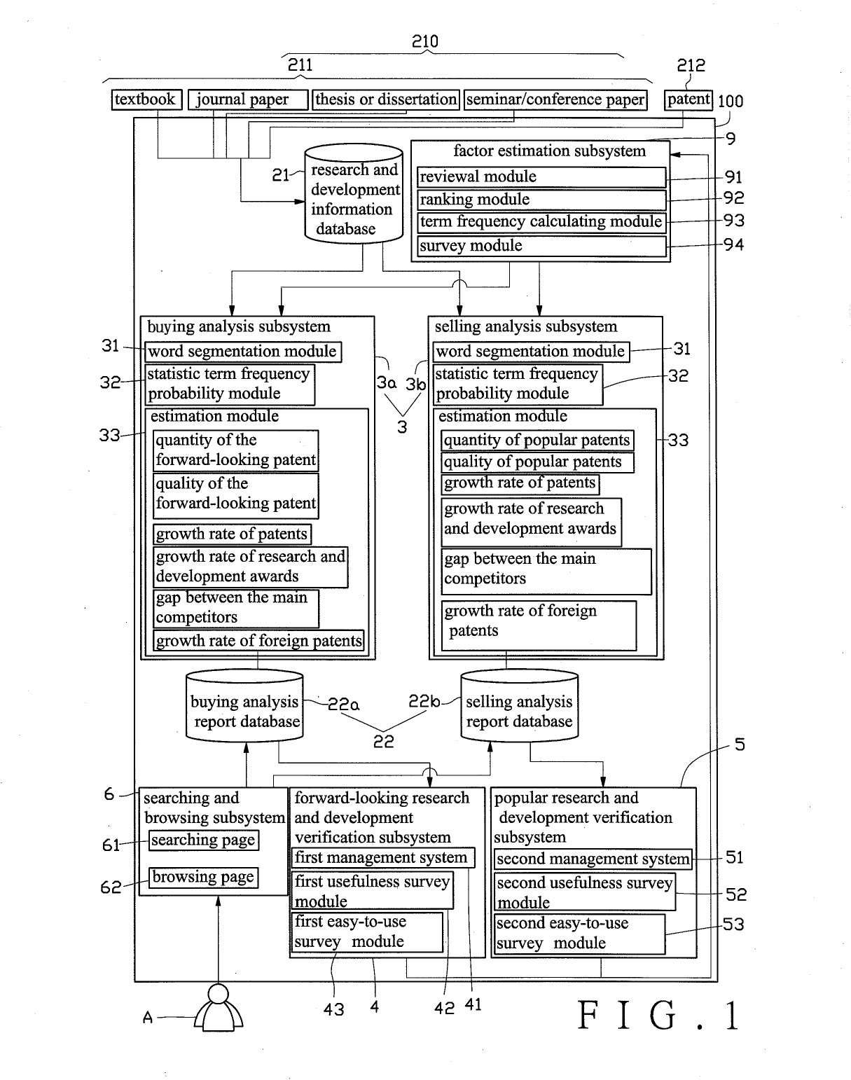

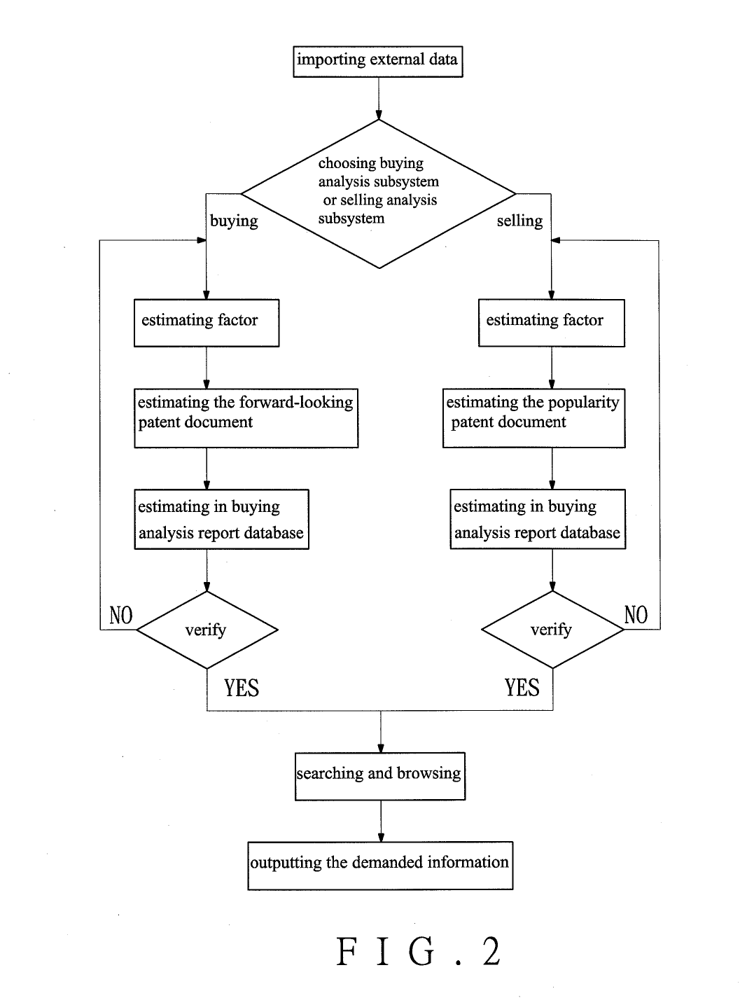

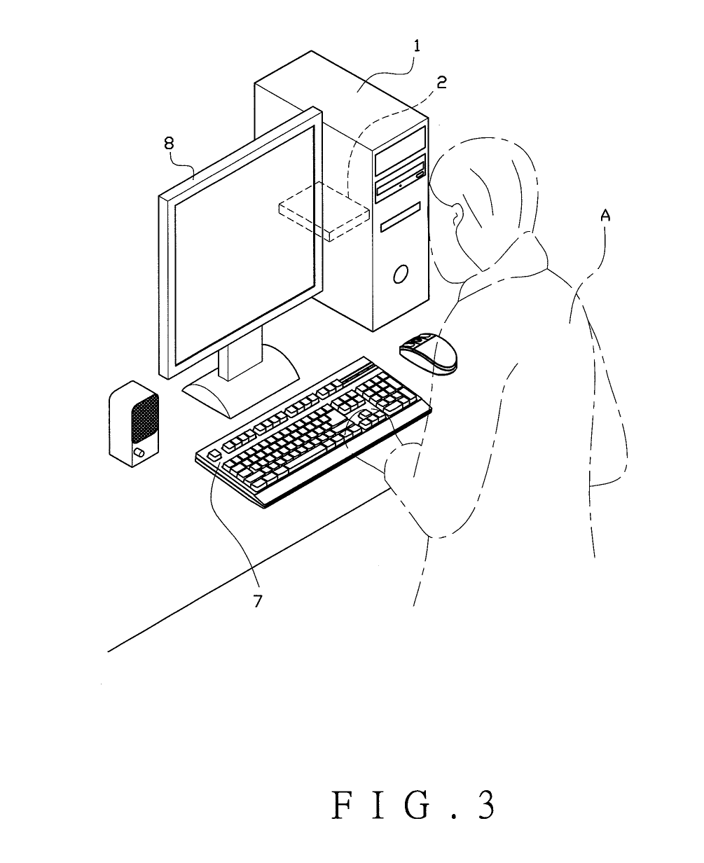

Referring to FIGS. 1 to 4 showing the present invention which comprises:

A processing unit 1 being defined as a personal computer, a notebook, a tablet PC, a cell phone, or a personal digital assistant (PDA).

A database module 2 connected to the processing unit 1. The database module 2 includes a research and development information database 21 and an analysis report database 22. The research and development information 21 is applied to import an external data 210. The external data 210 has at least one academic document 211 and at least one patent document 212. The academic document 211 is defined as a textbook, a journal paper, a thesis or a dissertation, a seminar/conference paper or a combination thereof. The analysis report database 22 is defined as a buying analysis report database 22a or/and a selling analysis report database 22b.

An investment analysis subsystem 3 built in the processing unit 1. The investment analysis subsystem 3 is connected to the research and development information database 21 and the analysis report database 22. The investment analysis subsystem 3 includes a word segmentation module 31, a statistic term frequency probability module 32, and an estimation module 33. The word segmentation module 31 is applied to segment the academic document 211 and the patent document 212 to generate a plurality of linguistic units. The statistic term frequency probability module 32 is applied to add up an appeared frequency of the linguistic units for sifting out a plurality of technical key words.

In a given document, a term frequency (TF) means a number of times of a given word appeared in the document.

The number of times is usually standardized to prevent from deflecting to the document with more content (The term frequency of a word in a document with a longer content may be higher than that of the word in a document with a shorter content irrespective of the importance of the word). For a word “t” in a single document, its importance TF can be represented as:

$$TF = \frac{{n}_{t}}{{N}_{t}}$$

From the above equation, nₜ shows the times of the word which appears in a document d; the denominator is the sum of times that all the words appear in the document d.

An inverse document frequency (IDF) is a metrology of general importance of a word. An IDF of a particular word can be obtained by dividing the number of sum-up documents by the quantity of documents in which the word is included and then taking the logarithm of the quotient. The calculation is shown as:

$$IDF = log \frac{\vert D \vert}{\vert \{ d \text{:} d ∋ t \} \vert}$$

Wherein,

|D|: The sum of the documents in the text corpus built from the research and development information database 21.

|{d:d [symbol] t}|: The quantity of the documents which includes the word t (the quantity of the documents should meet nₜ≠0), and

Wherein, a wording/term weight factor TF-IDF is calculated as the following equation:

TF-IDF=TF×IDF

A high term frequency in a particular document and a low document frequency of the word in the whole document set are able to generate a high wording weight factor TF-IDF. Therefore, the wording weight factor TF-IDF tends to sift out the common words and retain the important words.

The estimation module 33 determines a repeatability by comparing the technical key words of the patent document 212 with the technical key words of the academic document 211 to generate a technical relevancy and saves the technical relevancy in the analysis report database 22.

The technical meaning of the technical relevancy is explained in example. For instance, an academic document 211 relating LED backlight module is proceed by segmenting words and collecting the statistic term frequency probability to extract a backlight module, a light guide plate, a LED, a diffuser, and a brightness enhancement film therefrom; the patent document relating LED backlight module is proceed by segmenting words and collecting the statistic term frequency probability to extract a backlight module, a light guide plate, a LED, a diffuser, and a brightness enhancement film therefrom. In this case, the technical key words has a high repeatability, the patent document 212 and the academic documents are defined as a high technical relevancy. In contrast, if the repeatability of the technical key words of the patent document 212 subjected to the word segmentation and the statistic term frequency probability collection and the technical key words of the academic document 211 is low, the patent document 212 and the academic document are defined as a low technical relevancy.

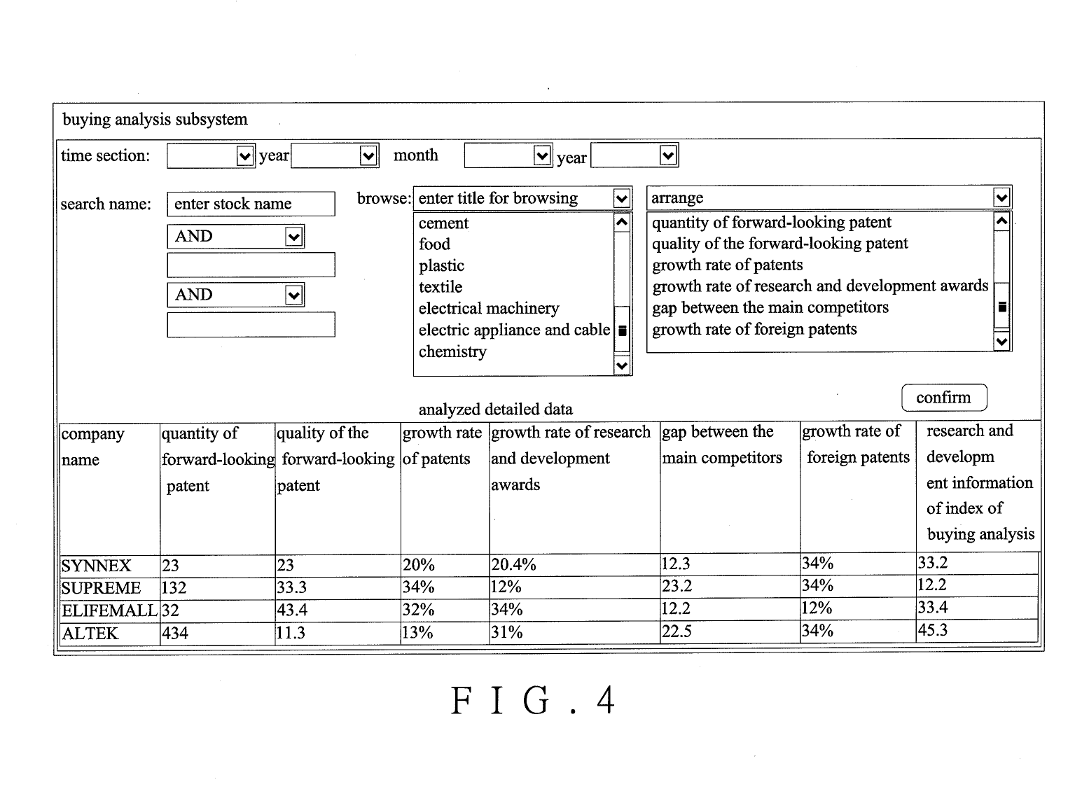

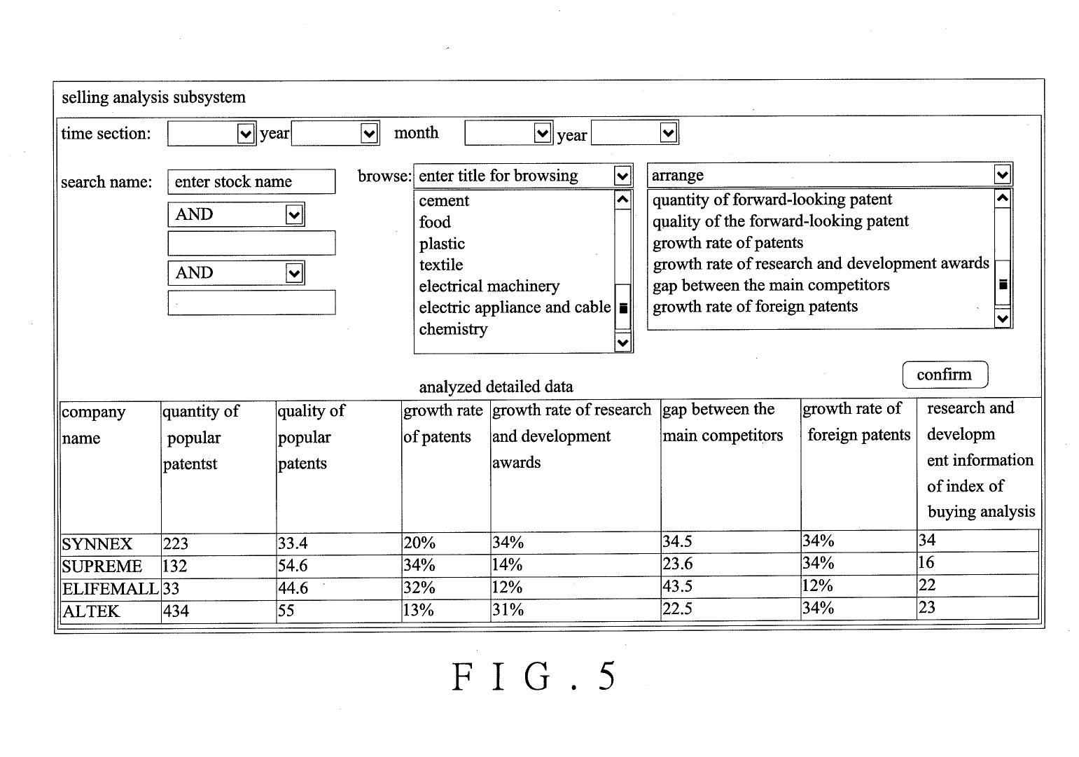

The investment analysis subsystem 3 is defined as a buying analysis subsystem 3a (referring to FIG. 4) or/and a selling analysis subsystem 3b (referring to FIG. 5):

A time period of the academic document 211 of the external data 210 adopted by the buying analysis subsystem 3a is set within n_{b} year(s). Preferably, n_{b} satisfies a condition of 0<n_{b}≦2, and the condition means that n_{b} is chosen within specific time period not larger than 2 years from a searching date or a chosen date. The estimation module 33 compares the technical relevancy of the academic document 211 and the patent document 212 to determine whether the patent document 212 is a forward-looking patent for a buying reference. The technical relevancy of the academic document 211 and the patent document 212 is applied to compute a buying reference index of a company. The calculation formula of the buying reference index includes:

Wi (quantity of the forward-looking patent): A number of the forward-looking patent owned by the company.

Wj (quality of the forward-looking patent): A number of times that the forward-looking patent owned by the company is quoted.

By knowing the quantity of forward-looking patent and the quality of forward-looking patent of the company, the forward-looking of the enterprise research and development technique is understandable for the investors to enter the market earlier when the future turnover and enterprise value are underestimated, thereby enhancing the investment profit.

Wy (growth rate of patents): A sum of granted patents within a time period of n_{y1} year(s)/a sum of granted patents for a time period of n_{y2} year(s). Preferably, n_{y1} and n_{y2} satisfy the condition of 0<n_{y1}≦1 and 0<n_{y2}≦2. By knowing the recent patents of the company, the variation of the company's involvement in the research and development technique is understandable.

Wz (growth rate of research and development awards): A sum of awards in research and development within a time period of n_{z1} year(s)/a sum of awards in research and development for a time period of n_{z2} year(s). Preferably, n_{z1} and n_{z2} satisfy the condition of 0<n_{z1}≦1 and 0<n_{z2}≦2. The research and development awards are usually awarded by an organization with public credibility, which gives the research development technique value of the company an objective determination. The situation of the research and development ability of the company is approximately inferred from the variation of the growth rate of the research and development award of the company.

Wk (patent gap rate of main competitors): A gap between patent quantity and quality of the company and competitors within nₖ₁ year(s). Preferably, nₖ₁ satisfies the condition of 0<nₖ₁≦1.

Wg (growth rate of foreign patents): A sum of granted foreign patents within a time period of n_{g1} year(s)/a sum of granted foreign patents for a time period of n_{g2} year(s). Preferably, n_{g1} and n_{g2} satisfy the condition of 0<n_{g1}≦1 and 0<n_{g2}≦2. The variation of the company's involvement in the international market of the company is known.

A time period of the academic document 211 of the external data 210 adopted by the selling analysis subsystem 3b is set for nₛ year(s), Preferably, nₛ satisfies a condition of 5≦nₛ≦10, and the condition means that nₛ is chosen within specific time period between a lower limited date and a upper limited date; wherein, the lower limited date is not smaller than 5 years from a searching date or a chosen date, and the upper limited date is not larger than 10 years from a searching date or a chosen date. The estimation module 33 compares the technical relevancy of the academic document 211 and the patent document 212 to determine whether the patent document 212 is a popular patent for a selling reference. The technical relevancy of the academic document 211 and the patent document 212 is applied to compute a selling reference index of a company. The calculation formula of the selling reference index includes:

Wm (quantity of popular patent): A number of the popular patent owned by the company;

Wn (quality of popular patent): A number of times that the popular patent owned by the company is quoted.

By knowing the quantity of popular patent and quality of popular patent of the company, it is understandable whether the research and development technique of the enterprise will face the vicious competition and price reduction strategy from other competitors for the investor to exit the market earlier before the turnover and the enterprise value are gradually reduced, thereby preventing investment profit from losing.

Wy (growth rate of patents): A sum of granted patents within a time period of n_{y3} year(s)/a sum of granted patents for a time period of n_{y4} year(s). Preferably, n_{y3} and n_{y4} satisfy the condition of 0<n_{y3}≦1 and 0<n_{y4}≦2. When the company faces the vicious competition and price reduction strategy, the invested fund of the research and development may be reduced and cause a decrease of growth rate of the patent.

Wz (growth rate of research and development awards): A sum of awards in research and development within a time period of n_{z3} year(s)/a sum of awards in research and development for a time period of n_{z4} year(s). Preferably, n_{z3} and n_{z4} satisfy the condition of 0<n_{z3}≦1 and 0<n_{z4}≦2. The situation that company is in a low tide of the research and development ability is also reflected in the variation of the growth rate of the research and development award;

Wk (patent gap rate of main competitors): A gap between patent quantity and quality of the company and competitors within nₖ₂ year(s). Preferably, nₖ₂ satisfy the condition of 0<nₖ₂≦1.

Wg (growth rate of foreign patents): A sum of granted foreign patents within a time period of n_{g3} year(s)/a sum of granted foreign patents for a time period of n_{g4} year(s). Preferably, n_{g3} and n_{g4} satisfy the condition of 0<n_{g3}≦1 and 0<n_{g4}≦2. If the competitiveness of the company is decreased, the company will gradually drop out of the overseas market and do not need to apply a foreign patent to protect the sales market, so the growth rate of the foreign patents is referable.

A forward-looking patent verification subsystem 4 is built in the processing unit 1. The forward-looking patent verification subsystem 4 is connected to the buying analysis report database 22a. The forward-looking patent verification subsystem 4 includes a first management module 41, a first usefulness survey module 42, and a first easy-to-use survey module 43. The first management module 41 is applied to verify years of the buying reference index in the buying analysis report database 22a. The first usefulness survey module 42 provides a usefulness-estimated questionnaire for estimating a usefulness of the buying reference index. The first easy-to-use survey module 43 provides a easy-to-use-estimated questionnaire for estimating an acceptance of a user interface of the buying analysis subsystem 3a.

A popular patent verification subsystem 5 is built in the processing unit 1. The popular patent verification subsystem 5 is connected to the selling analysis report database 22b. The popular patent verification subsystem 5 includes a second management module 51, a second usefulness survey module 52, and a second easy-to-use survey module 53. The second management module 51 is applied to verify years of the selling reference index in the selling analysis report database 22b. The second usefulness survey module 52 provides a usefulness-estimated questionnaire for estimating a usefulness of the selling reference index. The second easy-to-use survey module 53 provides a easy-to-use-estimated questionnaire for estimating an acceptance of a user interface of the selling analysis module.

A searching and browsing subsystem 6 is built in the processing unit 1, connected to the analysis report database 22, and provided with a searching page 61 and/or a browsing page 62.

An operation unit 7 is electrically connected to the processing unit 1 for inputting an operation signal. The operation unit 7 is defined as a keyboard, a mouse, a smart-pen, a graphics tablet, and a touch-screen or a combination thereof.

An output unit 8 is connected to the processing unit 1. The output unit is defined as a screen that renders the searching and browsing subsystem 6 output the technical relevancy of the analysis report database 22 to the browsing page 62.

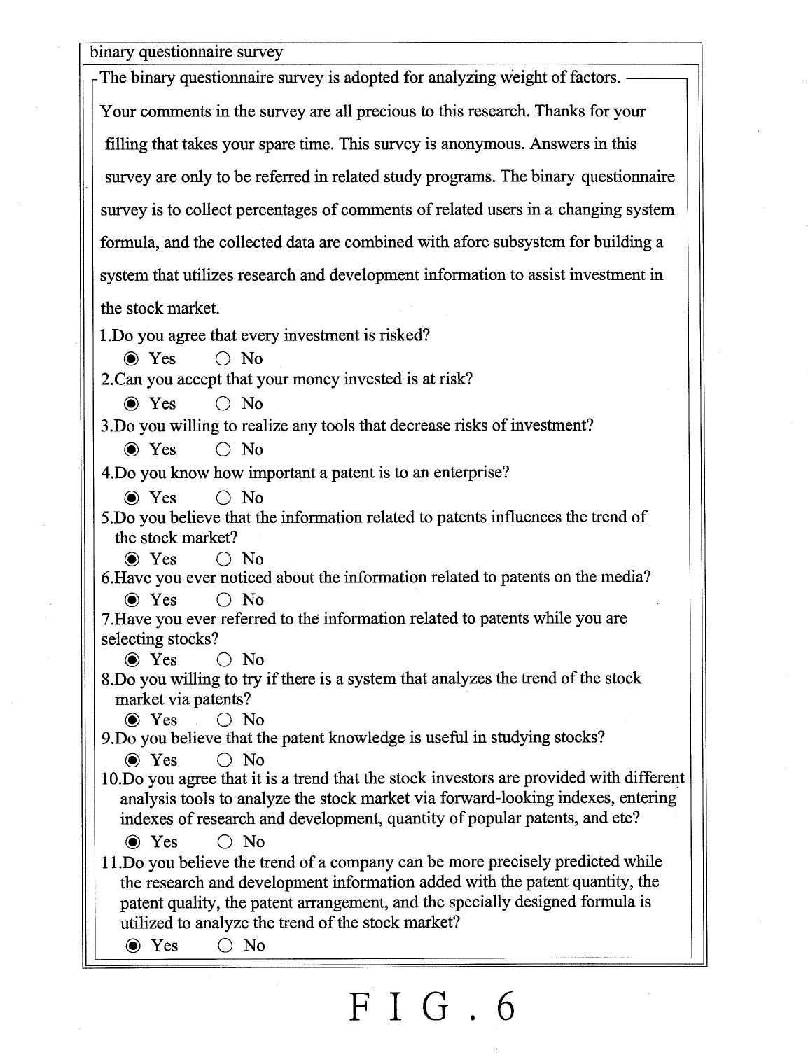

A factor estimation subsystem 9 is built in the processing unit 1. The factor estimation subsystem 9 is connected to the investment analysis subsystem 3. The factor estimation subsystem 9 includes a reviewal module 91, a ranking module 92, a term frequency calculating module 93, a binary questionnaire survey module 94 or a combination thereof. The reviewal module 91 is applied to control the investment analysis subsystem 3 to repeatedly confirm the technical relevancy, the buying reference index and/or the selling reference index. The ranking module 92 respectively arranges the technical relevancy, the buying reference index, and/or the selling reference index in corresponding ranking orders when the technical relevancy, the buying reference index, and/or the selling reference index are plural. The binary questionnaire survey module 94 is applied to provide at least one binary questionnaire (referring to FIG. 6), such that the investment analysis subsystem adjusts an analysis weight factor in accordance with a result of binary questionnaire. The analysis weight factor can be a feedback for updating the imported external data 210, or the buying and selling reference indexes anytime.

A method for research and development information assisting in investment is further provided and applied to a computer. The method uses a program to set up a program product and saves the program product in a recording media (does not shown in the figure) for loading in the computer (such as a personal computer, a notebook, a smart phone, a tablet PC, and a personal digital assistant (PDA)). Furthermore, the program product is able to be saved in a server for downloading online. The operation instruction is referred to the FIGS. 1 to 4.

An external data 210 is imported to the analysis report database 22. The external data 210 includes at least one academic document 211 and at least one patent document 212.

The academic document 211 and the patent document 212 are segmented by the word segmentation module 31 of the investment analysis subsystem 3 to generate a plurality of linguistic units. The statistic term frequency probability module 32 adds up an appeared frequency of the linguistic units for sifting out a plurality of technical key words. The estimation module 33 determines a repeatability by comparing the technical key words of the patent document 212 with the technical key words of the academic document 211 to generate a technical relevancy.

When the technical relevancy is referred to be the buying reference, a time period of the adopted academic document 211 of the external data 210 is set within n_{b} year(s) preferably satisfying a condition of n≦2. The patent document 212 is determined whether the patent document is a forward-looking patent for a buying reference by comparing the technical relevancy of the academic document 211 with the patent document 212 so as to compute a buying reference index of a company. A calculation formula of the buying reference index includes:

Wi (quantity of the forward-looking patent): A number of the forward-looking patent owned by the company;

Wj (quality of the forward-looking patent): A number of times that the forward-looking patent owned by the company is quoted.

When the technical relevancy is referred to be the selling reference, a time period of the adopted academic document 211 of the external data 210 is set for nₛ year(s) preferably satisfying a condition of 5≦nₛ≦10. The patent document 212 is determined whether the patent document is a popular patent for a selling reference by comparing the technical relevancy of the academic document 211 with the patent document 212 so as to compute a selling reference index of a company. A calculation formula of the selling reference index includes:

Wm (quantity of popular patent): A number of the popular patent owned by the company;

Wn (quality of popular patent): A number of times that the popular patent owned by the company is quoted.

The forward-looking patent verification subsystem 4, the popular patent verification subsystem 5, and the factor estimation subsystem 9 are proceed to verify the technical relevancy and make a feedback of verified result for updating the imported external data 210, or the buying and selling reference indexes anytime.

Therefore, the different users A, like experts, banks, securities firms, private investors, and investment consulting companies, can use the searching and browsing subsystem 6 to search the analysis report database 22 and show the searching result according to the importance on the output unit 8 for the users A to search and evaluate the forward-looking of the research and development technique of the enterprise or the fact that too many popular patents are owned, which allows the investor to enter the market earlier when the future turnover and the enterprise value are underestimated or exit earlier before the turnover and the enterprise value of the invested enterprise are reduced due to the vicious competition and price reduction strategy from other competitors.

While we have shown and described the embodiment in accordance with the present invention, it should be clear to those skilled in the art that further embodiments may be made without departing from the scope of the present invention.

1. A system for research and development information assisting in investment comprising:
a processing unit;
a database module connected to said processing unit; said database module including a research and development information database and an analysis report database; said research and development information being applied to import an external data; said external data having at least one academic document and at least one patent document;
an investment analysis subsystem built in said processing unit; said investment analysis subsystem being connected to said research and development information database and said analysis report database; said investment analysis subsystem comparing said academic document with said patent document to obtain a technical relevancy and saving said technical relevancy in said analysis report database; and
an output unit connected to said processing unit for outputting said technical relevancy of said analysis report database by said processing unit.

2. The system for research and development information assisting in investment as claimed in claim 1, wherein said investment analysis subsystem includes a word segmentation module, a statistic term frequency probability module, and an estimation module; said word segmentation module is applied to segment said academic document and said patent document to generate a plurality of linguistic units; said statistic term frequency probability module is applied to add up an appeared frequency of said linguistic units for sifting out a plurality of technical key words; said estimation module determines a repeatability by comparing said technical key words of said patent document with said technical key words of said academic document to generate said technical relevancy.

3. The system for research and development information assisting in investment as claimed in claim 1, wherein said analysis report database is a buying analysis report database; said investment analysis subsystem is a buying analysis subsystem; a time period of said academic document of said external data adopted by said buying analysis subsystem is set within n_{b} year(s) satisfying a condition of n_{b}≦2; said estimation module compares said technical relevancy of said academic document and said patent document to determine whether said patent document is a forward-looking patent for a buying reference.

4. The system for research and development information assisting in investment as claimed in claim 3, wherein said technical relevancy of said academic document and said patent document is applied to compute a buying reference index of a company; a calculation formula of said enter reference index includes:
Wi (quantity of said forward-looking patent): A number of said forward-looking patent owned by said company;
Wj (quality of said forward-looking patent): A number of times that said forward-looking patent owned by said company is quoted.

5. The system for research and development information assisting in investment as claimed in claim 4, wherein said calculation formula of said company's enter reference index further includes:
Wy (growth rate of patents): A sum of granted patents within a time period of n_{y1} year(s) satisfying a condition of n_{y1}≦1/a sum of granted patents for a time period of n_{y2} year(s) satisfying a condition of n_{y2}≦2;
Wz (growth rate of research and development awards): A sum of awards in research and development within a time period of n_{z1} year(s) satisfying a condition of n_{z1}≦1/a sum of awards in research and development for a time period of n_{z2} year(s) satisfying a condition of n_{z2}≦2;
Wk (patent gap rate of main competitors): A gap between patent quantity and quality of said company and competitors within nₖ₁ year(s) satisfying a condition of nₖ₁≦1;
Wg (growth rate of foreign patents): A sum of granted foreign patents within a time period of n_{g1} year(s) satisfying a condition of n_{g1}≦1/a sum of granted foreign patents for a time period of n_{g2} year(s) satisfying a condition of n_{g2}≦2.

6. The system for research and development information assisting in investment as claimed in claim 1, wherein said analysis report database is a selling analysis report database; said investment analysis subsystem is a selling analysis subsystem; a time period of said academic document of said external data adopted by said selling analysis subsystem is set for nₛ year(s) satisfying a condition of 5≦nₛ≦10; said estimation module compares said technical relevancy of said academic document and said patent document to determine whether said patent document is a popular patent for a selling reference.

7. The system for research and development information assisting in investment as claimed in claim 6, wherein said technical relevancy of said academic document and said patent document is applied to compute a selling reference index of a company; a calculation formula of said exit reference index includes:
Wm (quantity of popular patent): A number of said popular patent owned by said company;
Wn (quality of popular patent): A number of times that said popular patent owned by said company is quoted.

8. The system for research and development information assisting in investment as claimed in claim 7, wherein said calculation formula of said company's exit reference index includes:
Wy (growth rate of patents): A sum of granted patents within a time period of n_{y3} year(s) satisfying a condition of n_{y3}≦1/a sum of granted patents for a time period of n_{y4} year(s) satisfying a condition of n_{y4}≦2;
Wz (growth rate of research and development awards): A sum of awards in research and development within a time period of n_{z3} year(s) satisfying a condition of n_{z3}≦1/a sum of awards in research and development for a time period of n_{z4} year(s) satisfying a condition of n_{z4}≦2;
Wk (patent gap rate of main competitors): A gap between patent quantity and quality of said company and competitors within nₖ₂ year(s) satisfying a condition of nₖ₂≦1;
Wg (growth rate of foreign patents): A sum of granted foreign patents within a time period of n_{g3} year(s) satisfying a condition of n_{g3}≦1/a sum of granted foreign patents for a time period of n_{g4} year(s) satisfying a condition of n_{g4}≦2.

9. The system for research and development information assisting in investment as claimed in claim 3, further includes a forward-looking patent verification subsystem; said forward-looking patent verification subsystem is built in said processing unit; said forward-looking patent verification subsystem is connected to said buying analysis report database; said forward-looking patent verification subsystem includes a first management module, a first usefulness survey module, and a first easy-to-use survey module; said first management module is applied to verify year(s) of said enter reference index in said buying analysis report database; said first usefulness survey module provides a usefulness-estimated questionnaire for estimating a usefulness of said enter reference index; said first easy-to-use survey module provides a easy-to-use-estimated questionnaire for estimating an acceptance of a user interface of said buying analysis module.

10. The system for research and development information assisting in investment as claimed in claim 6, further includes a popular patent verification subsystem; said popular patent verification subsystem is built in said processing unit; said popular patent verification subsystem is connected to said selling analysis report database; said popular patent verification subsystem includes a second management module, a second usefulness survey module, and a second easy-to-use survey module; said second management module is applied to verify year(s) of said exit reference index in said selling analysis report database; said second usefulness survey module provides a usefulness-estimated questionnaire for estimating a usefulness of said exit reference index; said second easy-to-use survey module provides a easy-to-use-estimated questionnaire for estimating an acceptance of a user interface of said selling analysis module.

11. The system for research and development information assisting in investment as claimed in claim 1, further includes a searching and browsing subsystem and an operation unit; said searching and browsing subsystem is built in said processing unit and connected to said analysis report database; said operation unit is electrically connected to said processing unit for inputting an operation signal; said output unit is defined as a screen for said processing unit to output a searching page and/or a browsing page in accordance with said operation signal.

12. The system for research and development information assisting in investment as claimed in claim 1, further includes a factor estimation subsystem built in said processing unit; said factor estimation subsystem is connected to said investment analysis subsystem; said factor estimation subsystem includes a reviewal module, a ranking module, a term frequency calculating module, a binary questionnaire survey module or a combination thereof; said reviewal module is applied to control said investment analysis subsystem to repeatedly confirm said technical relevancy; said rank module arranges said technical relevancy in order of integrations when said technical relevancy is plural; said binary questionnaire survey module is applied to provide at least one binary questionnaire and render said investment analysis subsystem able to adjust an analysis weight factor in accordance with a result of said binary questionnaire.

13. A system for research and development information assisting in investment comprising:
a processing unit;
a database module connected to said processing unit; said database module including a research and development information database, a buying analysis report database, and a selling analysis report database; said research and development information database being applied to import an external data; said external data including at least one academic document and at least one patent document;
a buying analysis subsystem built in said processing unit; said investment analysis subsystem being connected to said research and development information database and said buying analysis report database; a time period of said academic document of said external data adopted by said buying analysis subsystem being set within n_{b} year(s) satisfying a condition of n_{b}≦2; said estimation module compared said technical relevancy of said academic document and said patent document to determine whether said patent document is a forward-looking patent for a buying reference;
said buying analysis subsystem applying said technical relevancy of said academic document and said patent document for computing a buying reference index of a company; a calculation formula of said enter reference index includes:
Wi (quantity of said forward-looking patent): A number of said forward-looking patent owned by said company;
Wj (quality of said forward-looking patent): A number of times that said forward-looking patent owned by said company is quoted;
a selling analysis subsystem built in said processing unit; said investment analysis subsystem being connected to said research and development information and said selling analysis report database; a time period of said academic document of said external data adopted by said selling analysis subsystem is set for nₛ year(s) satisfying a condition of 5≦nₛ≦10; said estimation module compares said technical relevancy of said academic document and said patent document to determine whether said patent document is a popular patent for a selling reference;
said selling analysis subsystem applying said technical relevancy of said academic document and said patent document for computing a selling reference index of said company; a calculation formula of said exit reference index includes:
Wm (quantity of popular patent): A number of said popular patent owned by said company;
Wn (quality of popular patent): A number of times that said popular patent owned by said company is quoted;
a factor estimation subsystem built in said processing unit; said factor estimation subsystem being connected to said investment analysis subsystem; said factor estimation subsystem including a reviewal module, a ranking module, a term frequency calculating module, a binary questionnaire survey module or a combination thereof; said reviewal module being applied to repeatedly confirm said technical relevancy, said enter reference index, and said exit reference index; said ranking module arranging said technical relevancy, said enter reference index, and said exit reference index in order of integrations when said technical relevancy, said enter reference index, and said exit reference index being plural; said binary questionnaire survey module being applied to provide at least one binary questionnaire and render said investment analysis subsystem able to adjust an analysis weight factor in accordance with a result of binary questionnaire; and
an output unit connected to said processing unit for outputting said technical relevancy, said enter reference index, and said exit reference index of said analysis report database by said processing unit.

14. A method for researching and developing information assisting in investment, comprising the steps of:
importing an external data to a database module connected to a processing unit; said external data including at least one academic document and at least one patent document; and
comparing, by the processing unit, said academic document with said patent document resulting in a technical relevancy.

15. The method for research and development information assisting in investment as claimed in claim 14, wherein said steps comprises verifying said technical relevancy and making a feedback of verified result for updating data anytime.

16. The method for research and development information assisting in investment as claimed in claim 14, wherein said steps comprises segmenting said academic document and said patent document to generate a plurality of linguistic units, adding up an appeared frequency of said linguistic unit for sifting out a plurality of technical key words, and comparing a repeatability of said technical key words of said patent document with said technical key words of said academic document to generate said technical relevancy.

17. The method for research and development information assisting in investment as claimed in claim 14, wherein a time period of said adopted academic document of said adopted external data is set within n_{b} year(s) satisfying a condition of n_{b}≦2; said patent document is determined whether said patent document is a forward-looking patent for a buying reference by comparing said technical relevancy of said academic document and said patent document.

18. The method for research and development information assisting in investment as claimed in claim 17, wherein said technical relevancy of said academic document and said patent document is applied to compute a buying reference index of a company; a calculation formula of said enter reference index includes:
Wi (quantity of said forward-looking patent): A number of said forward-looking patent owned by said company;
Wj (quality of said forward-looking patent): A number of times that said forward-looking patent owned by said company is quoted.

19. The method for research and development information assisting in investment as claimed in claim 14, wherein a time period of said adopted academic document of said external data is set for nₛ year(s) satisfying a condition of 5≦nₛ≦10; said patent document is determined whether said patent document is a popular patent for a selling reference by comparing said technical relevancy of said academic document and said patent document.

20. The method for research and development information assisting in investment as claimed in claim 19, wherein said technical relevancy of said academic document and said patent document is applied to compute a selling reference index of a company; a calculation formula of said exit reference index includes:
Wm (quantity of popular patent): A number of said popular patent owned by said company;
Wn (quality of popular patent): A number of times that said popular patent owned by said company is quoted.

21. A computer program product comprising a non-transitory computer readable medium, the computer program product comprising instructions that when loaded in a processing unit, execute the following steps:
importing an external data to a database module connected to a processing unit; said external data including at least one academic document and at least one patent document; and
comparing, by the processing unit, said academic document with said patent document resulting in a technical relevancy.

22. A non-transitory readable and recordable medium for a computer, the medium comprising computer instructions that when executed, perform at least the following steps:
importing an external data to a database module connected to a processing unit; said external data including at least one academic document and at least one patent document; and
comparing, by the processing unit, said academic document with said patent document resulting in a technical relevancy.
